(19) United States
(12) Patent Application Publication
(10) Pub. No.: US 2006/0086239 A1
(43) Pub. Date: Apr. 27, 2006

(54) Apparatus and method for reproducing MIDI file

(75) Inventors: Jae Hyuck Lee, Seoul (KR); Jung Min Song, Seoul (KR); Yong Chul Park, Seoul (KR); Jun Yup Lee, Yongin-si (KR)

Correspondence Address: JONATHAN Y. KANG, ESQ.;LEE, HONG, DEGERMAN, KANG & SCHMADEKA, 801 S. Figueroa Street, 14th Floor, Los Angeles, CA, 90017, US

(73) Assignee: LG Electronics Inc.

(21) Appl. No.: 11/259,601

(22) Filed: Oct. 25, 2005

(30) Foreign Application Priority Data
Oct. 27, 2004 (KR) 10-2004-0086063

(51) Int. Cl. G10H 7/00

(52) U.S. Cl. 84/645

(57) ABSTRACT

Apparatus and method for reproducing a MIDI file are provided. In the apparatus and the method, notes and note reproduction times are extracted from the MIDI file and a difference between a start point and an end point in a Loop section of relevant sound source data according to the note reproduction time is detected and stored. The above stored difference between the start point and end point of the sound source data which will be reproduced is compensated and outputted, so that sound quality distortion in the Loop section is eliminated or reduced.

### CROSS REFERENCE TO RELATED APPLICATIONS

Pursuant to 35 U.S.C. §119(a), this application claims the benefit of earlier filing date and right of priority to Korean Patent Application No. 10-2004-0086063, filed on Oct. 27, 2004 the content of which is hereby incorporated by reference herein in its entirety.

### BACKGROUND OF THE INVENTION

1. Field of the Invention

The present invention relates to an apparatus and a method for reproducing a MIDI-based music file.

2. Description of the Related Art

To reproduce a musical instrument digital interface (MIDI) file into a real sound, many methods can be used. Representative methods include a frequency modulation (FM) synthesis method and a wave table synthesis method. The FM synthesis method reproduces a sound by synthesizing basic waveforms. Since the FM synthesis method does not require a separate sound source, it has an advantage of using a small amount of memory but has a disadvantage of not reproducing a natural sound close to an original sound. On the contrary, the wave table synthesis method stores sound sources for each instrument and each note of each instrument in advance and synthesizes these sound sources to reproduce a sound. The wave table synthesis method has a disadvantage of using a large amount of memory in storing the sound sources, but has an advantage of reproducing a natural sound close to an original sound.

To hear a sound in real-time through a MIDI file reproducing system, a process of synthesizing a sound using a MIDI file and a sound source should be performed in real-time. A process of synthesizing a sound requires a considerable amount of processor resources.

To synthesize a MIDI-based sound, a desired sound is synthesized using one wave table containing a plurality of sound sources. Therefore, all of sounds are generated using the sound sources of the wave table. The sound sources are stored in a single sampling rate. When the sampling rate of a sound source and a sampling rate of a sound that is desired to be reproduced is the same in synthesizing a MIDI-based sound, the sound can be reproduced without frequency-conversion.

However, the sampling rate of a sound source can be different from that of a sound which will be reproduced. In that case, all of notes that are desired to be reproduced should be frequency-converted. That is, a process of converting the sampling rate of a current sound source into an output sampling rate of a sound that is desired to be reproduced, is required. At this point, a processor is overloaded in its calculation amount.

FIG. 1 is a view of an apparatus for reproducing a MIDI file. A MIDI parser 11 extracts a plurality of notes and note reproduction times from the MIDI file to deliver the same to a MIDI sequencer 12. The MIDI sequencer 12 sequentially outputs the extracted note reproduction times. A wave table 14 has at least one sound source sample registered therein, and a frequency converter 13 frequency-converts at least one sound sample registered in the wave table 14 into sound source samples that correspond to respective notes whenever the note reproduction time is outputted from the MIDI sequencer 12.

The sound source of the wave table is divided into an Attack part and a Loop part. To reproduce a sound that continues while exceeding the length of a stored sound source, the initial Attack part is reproduced, and after that, the reproduction is performed by going back to the start point of the Loop part from the end point of the Loop part. At this point, when the end point is different from the start point of the Loop part, sound quality deterioration and noises are generated. That is, the sound quality deterioration and noises are generated due to the phenomenon that the end point of the Loop part becomes different from the staring point of the Loop part during the process of converting the sampling rate of a sound source into the output sampling rate of a sound which will be reproduced.

When the reproduction time for the note is inputted, the frequency converter 13 judges whether a sound source for the relevant note is present in the wave table 14 and frequency-converts the note into a sound source that correspond to the relevant note.

In the case where a sound source for the relevant note is not present in the wave table 14, the frequency converter 13 reads a predetermined sound source sample from the wave table 14 and frequency-converts the read sound source sample into a sound source sample that corresponds to the relevant note. In the case where a sound source for the relevant note is present in the wave table 14, the frequency converter 13 reads the relevant sound source sample from the wave table 14 and outputs the same without a separate frequency conversion.

The above processes are repeatedly performed whenever the note reproduction time for each note is inputted. However, in the case where the frequency conversion is repeatedly performed whenever the note reproduction time for each note is inputted as described above, a considerable amount of operations is required, so that the relevant processor can be overloaded. Moreover, the relevant MIDI file should be reproduced and outputted in real-time. However, since the frequency conversion is performed for each note as described above, music may not be reproduced in real-time. In short, the MIDI reproducing apparatus can reproduce music substantially only in the case where it uses a considerable amount of processor resources.

### SUMMARY OF THE INVENTION

Accordingly, the present invention is directed to an apparatus and a method for reproducing a MIDI file that substantially obviate one or more problems due to limitations and disadvantages of the related art.

An object of the present invention is to provide an apparatus and a method for reproducing a MIDI file, capable of preventing sound quality deterioration generated when the sampling rate of a sound source is converted in a wave table synthesis method.

Another object of the present invention is to provide an apparatus and a method for reproducing a MIDI file, capable of suppressing sound quality deterioration and noises generated because the end point of a Loop part is different from the start point of the Loop part during a process of synthesizing the MIDI file into a sound, and synthesizing a sound on the basis of the MIDI file to secure a high quality sound when reproducing the MIDI file.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, there is provided an apparatus for reproducing a MIDI file, the apparatus including: a MIDI parser for extracting notes and note reproduction times from the MIDI file; a MIDI sequencer for sequentially outputting the note reproduction times; a wave table for storing sound source samples; a preprocessor for storing information (meta data) regarding a size difference between the start points and the end points of Loop sections of sound sources; and a frequency converter for compensating differences between sound sources using the meta data and outputting the same when reproducing a sound.

In another aspect of the present invention, there is provided a method for reproducing a MIDI file, the method including: extracting notes and note reproduction times from the MIDI file; storing information (meta data) regarding a size difference between the start points and the end points of Loop sections of sound sources; compensating for differences between sound sources using the meta data when reproducing a sound; and outputting the compensated sound sources according to the note reproduction times.

According to the apparatus and the method of the present invention, since information regarding a frequency difference generated when the sampling rate of a sound source is converted is used at an frequency-conversion operation for reproducing and outputting a relevant sound and the relevant sound can be reproduced without deterioration of sound quality, noises due to repeated reproduction of a sound source are reduced. Also, since instant frequency trembling is prevented, sound quality of a MIDI-synthesized sound can be improved.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a view of an apparatus for reproducing a MIDI file;

FIG. 2 is a view illustrating an envelope when a MIDI file is reproduced;

FIG. 3 is a view of an apparatus for reproducing a MIDI file according to an embodiment of the present invention; and

FIG. 4 is a flowchart of a method for reproducing a MIDI file according to an embodiment of the present invention.

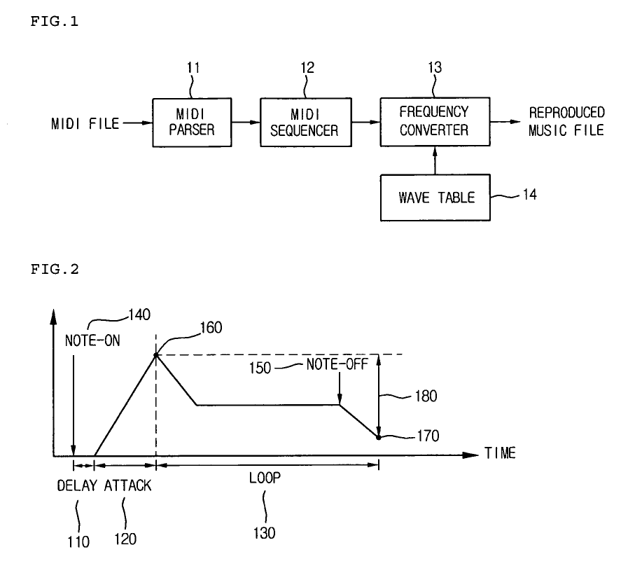

### DETAILED DESCRIPTION OF THE INVENTION

Reference will now be made in detail to the preferred embodiments of the present invention, examples of which are illustrated in the accompanying drawings.

FIG. 2 is a view illustrating an envelope waveform when a MIDI file is reproduced.

Examination of the envelope when a MIDI file is reproduced shows that a Delay part 110 continues after Note-On 140, and after that, the envelope includes an Attack part 120 and a Loop part 130. Though the envelope is expressed in a linear form in FIG. 2, it can have a linear form or a concave form depending on the kind of the envelope and the characteristic of each step. Also, articulation data, which is information representing a unique characteristic of a sound source, contains time information for the Attack part 120 and the Loop part 130, and is used in synthesizing a sound. One note is reproduced by applying the above envelope and a plurality of notes are gathered to complete one musical piece.

When one note is reproduced repeatedly using the envelope of FIG. 2 for example, the envelope after Note-Off 150 should reduce and reach an end point 170 and the end point 170 should be smoothly tied to the start point 160 of the envelope. However, in the case where the sampling rate of the end point 170 is different from that of the start point 160, a frequency changes instantly and sound quality is deteriorated and noises are generated. The deterioration of sound quality and generation of noises increase as a frequency difference 180 between the start point 160 and the end point 170 increases. To prevent above problem, a sampling rate is controlled such that the frequency at the start point 160 may be the same as the frequency at the end point 170.

However, since the storage space of the wave table is limited, the wave table stores a note having one frequency only and converts the frequency of the note to output a desired sound when reproducing a sound. When a sound source is converted in a desired sampling rate, frequencies at the start point 160 and the end point 170 change during the conversion process as described above.

According to the present invention, information regarding a frequency difference between the start point 160 and the end point 170 is stored in advance and frequency-conversion is performed, so that compensation of a relevant note is performed using the stored information when the relevant note is reproduced. Therefore, sound quality deterioration due to conversion of sampling rate is reduced or prevented.

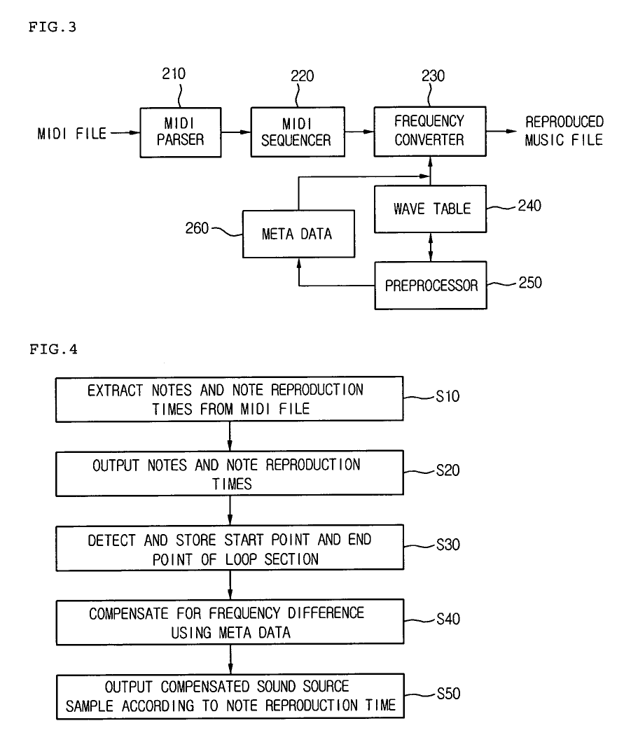

FIG. 3 is a view of an apparatus for reproducing a MIDI file according to an embodiment of the present invention.

The apparatus includes: a MIDI parser 210 for extracting a plurality of notes and notes reproduction times from the MIDI file; a MIDI sequencer 220 for outputting sound source samples according to the note reproduction times extracted from the MIDI parser 210; a wave table 240 for registering the sound source samples; a preprocessor 250 for storing a frequency difference between a start point 160 and an end point 170 of a Loop part of a sound source stored in the wave table 240; and a frequency converter 230 for compensating a frequency difference in a Loop section of a relevant sound source on the basis of meta data 260, which is frequency information at the start point 160 and the end point 170 stored in the preprocessor 250, and outputting the same.

The MIDI file contains information regarding predetermined music stored in advance in a storage medium thereof. The MIDI file can include a plurality of notes and note reproduction times. A note is information representing a sound. For example, the note represents information (e.g., Do, Re, and Mi) regarding a musical scale. Since the note is not a real sound, it should be reproduced into actual sound sources. A musical scale can include a range of 1-128 notes. A MIDI file can be a musical piece consisting of a start and an end of one song. This musical piece can include numerous musical scales and time lengths of respective musical scales. Therefore, a MIDI file can contain information regarding notes that correspond to respective musical scales and the reproduction times of the respective notes. The note reproduction time means a reproduction time of each of the notes contained in the MIDI file and is information regarding the same length of a sound. For example, when the reproduction time of a note “Re” is ⅛ second, a sound source that corresponds to the note “Re” is reproduced for ⅛ second when it is reproduced.

When a MIDI file is inputted, the MIDI parser 210 parses the MIDI file to extract a plurality of notes and note reproduction times contained therein. Here, the note reproduction times mean respective reproduction times of the respective notes. The MIDI file inputted to the MIDI parser 210 can contain tens of notes through 128 notes regarding a musical scale. The notes parsed by the MIDI parser 210 are inputted to the MIDI sequencer 220.

The MIDI sequencer 220 that receives the respective reproduction times of respective notes from the MIDI parser 210 sequentially reads, from the wave table 240, sound source samples that correspond to respective notes according to the respective reproduction times of the respective notes and outputs the same, so that the reproduction of the MIDI file can be performed.

Sound sources for each instrument and each note of each instrument are registered in the wave table 240. A musical scale includes 1 to 128 notes. However, there is a limitation in registering all of sound sources for the musical scale (i.e., notes contained therein) in the wave table 240. Therefore, sound source samples for only several representative notes are registered in the wave table 240. Therefore, to reproduce notes contained in the MIDI file using the sound source samples registered in the wave table 240, the sound source samples of the wave table 240 should be frequency-converted into sound source samples that correspond to the notes contained in the MIDI file and reproduced.

The present invention reduces or eliminates noises and improves sound quality by storing meta data as information regarding a frequency difference between the start point 160 and the end point 170 in the Loop section of a sound source before the sound source is reproduced and reflecting the meta data to the process of synthesizing a sound.

For that purpose, the present invention includes a preprocessor 250 for storing in advance information 260 (i.e. meta data) regarding a difference between the start point 160 and the end point 170 in the Loop section of a sound source, and a frequency converter 230 that uses the meta data 260 when reproducing a sound.

The preprocessor 250 stores in advance information (i.e., meta data) regarding a difference between the start point 160 and the end point 170 in the Loop section of a sound source. The difference is generated when the sampling rate of a sound source is converted into a desired sampling rate. When reproduction of a note continues, the frequency converter 230 compensates for a relevant frequency difference when the end point 170 returns back to the start point 160 of the sound source using the meta data stored in advance by the preprocessor 250, thereby preventing sound quality deterioration.

When the reproduction time for the note is inputted, the frequency converter 230 judges whether a sound source for the relevant note is present in the wave table 240 and frequency-converts the note into a sound source that correspond to the relevant note depending on existence of the sound source. The frequency converter 230 may be an oscillator.

In the case where the sound source for the relevant note is not present in the wave table 240, the frequency converter 230 reads a predetermined sound source sample from the wave table 240 and frequency-converts the read sound source sample into a sound source sample that corresponds to the relevant note. In the case where the sound source for the relevant note is present in the wave table 240, the frequency converter 230 reads the relevant sound source sample from the wave table 240 and outputs the same without a separate frequency conversion. For example, in the case where a sound source sample registered in the wave table 240 is sampled by 20 kHz and a note of desired music is sampled by 40 kHz, the sound source sample of 20 kHz is finally frequency-converted and reproduced. That is, the sound source sample of 20 kHz can be frequency-converted and outputted into a sound source sample of 40 kHz by the frequency converter 230.

The above processes are repeatedly performed whenever the note reproduction time for each note is inputted.

In the case where the note contained in the MIDI file is repeatedly reproduced, sound quality deterioration and noises can be generated due to a frequency difference between the start point 160 and the end point 170 of the Loop part 130. According to the present invention, the preprocessor 250 detects the frequency difference 180 (i.e., meta data) between the start point 160 and the end point 170 and stores the same therein, and the frequency converter 230 compensates for the frequency difference using the meta data 260 stored in the preprocessor 250, so that the frequency difference and sound quality deterioration generated in the Loop section due to conversion of the sampling rate can be solved.

FIG. 4 is a flowchart of a method for reproducing a MIDI file according to an embodiment of the present invention.

The first operation S10 is an operation for extracting notes and note reproduction times from a MIDI file. The MIDI parser 210 performs the operation S10.

The second operation S20 is an operation for sequentially outputting the notes and the note reproduction times extracted from the MIDI parser 210. The MIDI parser 220 performs the operation S20.

The third operation S30 is an operation for detecting difference information between a start point and an end point in a Loop section of relevant sound source data according to the note reproduction time and storing the same. The preprocessor 250 performs the operation S30.

The fourth operation S40 is an operation for compensating the difference between the start point and the end point of sound source data which will be reproduced. The frequency converter 230 performs the operation S40 on the basis of the meta data 260.

The fifth operation S50 is an operation for reproducing and outputting, at the frequency converter 230, relevant sound source data according to the notes and note reproduction times from the MIDI sequencer. That is, the operation S50 is an operation for reproducing and outputting a MIDI file where frequency differences between start point and end point have been compensated.

As described above, in the MIDI synthesis based on the wave table synthesis, the difference (meta data) between the start point and the end point of the Loop section is detected when a note is continuously reproduced, and the detected meta data is stored in the preprocessor 250. The frequency converter 230 compensates for the frequency difference using the meta data stored in the preprocessor 250 to perform reproduction of a relevant MIDI file.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. An apparatus for reproducing a MIDI file, the apparatus comprising:
means for extracting notes and note reproduction times from the MIDI file;
means for storing sound source data;
means for storing information of a start point and an end point in a Loop section of relevant sound source data according to the note reproduction time; and
means for reproducing and outputting the relevant sound source data according to the start point and the end point on the basis of the note and note reproduction time.

2. The apparatus according to claim 1, wherein the means for storing the information of the start point and the end point stores information regarding a difference between the start point and the end point in the Loop section of the sound source data.

3. The apparatus according to claim 1, wherein the means for storing the information of the start point and the end point stores information regarding a difference between the start point and the end point in the Loop section generated when a sampling rate of a sound source sample is converted.

4. The apparatus according to claim 1, wherein the means for reproducing and outputting the relevant sound source data applies the information of the start point and the end point of the Loop section to compensate for a frequency difference of a relevant sound source sample.

5. The apparatus according to claim 1, wherein the means for reproducing and outputting the relevant sound source data is a frequency converter for matching a sampling rate of a sound source sample with that of a desired sound source sample.

6. The apparatus for reproducing a MIDI file, the apparatus comprising:
a MIDI parser for extracting notes and note reproduction times from the MIDI file;
a MIDI sequencer for sequentially outputting the note reproduction times;
a sound source storage for storing sound source samples on the basis of a wave table; and
a frequency converter for compensating a difference between a start point and an end point of sound source data which will be reproduced to reproduce and output the sound source data according to the note and note reproduction times from the MIDI sequencer.

7. A method for reproducing a MIDI file, the method comprising:
extracting notes and note reproduction times from the MIDI file;
detecting and storing a difference between a start point and an end point in a Loop section of relevant sound source data according to the note reproduction time; and
compensating for a difference between the stored start point and end point of sound source data which will be reproduced and outputting the compensated sound source data.

8. The method according to claim 7, wherein the difference between the start point and the end point is difference information between the start point and the end point of the Loop section generated when a sampling rate of a sound source sample is converted.

9. The method according to claim 7, wherein the compensating of the difference comprises: applying information of the stored start point and end point of the Loop section to compensate for a frequency difference of a relevant sound source sample.

10. The method according to claim 7, wherein the compensating of the difference comprises: performing frequency conversion for matching a sampling rate of a sound source sample with that of a desired sound source sample.

11. The method according to claim 7, wherein reproduction of the MIDI file is based on a wave table synthesis method.

12. The method according to claim 7, wherein the difference between the start point and the end point is a frequency difference due to conversion of a sampling rate.
